(19) United States
(12) Patent Application Publication
(10) Pub. No.: US 2008/0044107 A1
(43) Pub. Date: Feb. 21, 2008

(54) Storage device for storing image data and method of storing image data

(75) Inventor: Yasunobu Horisaki, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/634,109

(22) Filed: Dec. 6, 2006

(30) Foreign Application Priority Data
Aug. 18, 2006 (JP) 2006-223189

(51) Int. Cl. G06K 9/34; G06K 9/54; G06K 9/60

(52) U.S. Cl. 382/305; 382/173

(57) ABSTRACT

The image data storage device according to the present invention comprises, a plurality of memory devices, a data division unit for dividing the image data into units of the constant number of consecutive lines or into units of pixel rows each including the constant number of pixels respectively corresponding to the plurality of memory devices, and a memory device control unit for sequentially storing the divided data in the plurality of memory devices.

### CROSS-REFERENCE TO RELATED APPLICATIONS

This application is based upon and claims the benefit of priority from the prior Japanese Patent Application No. 2006-223189 filed on Aug. 18, 2006, the entire contents of which are incorporated herein by reference.

### BACKGROUND OF THE INVENTION

1. Field of the Invention

The present invention relates to memory accessing methods used for image data storage devices each comprising a plurality of memory devices, and more particularly to image data storage devices for storing, in a plurality of memory devices such as dynamic random access memory devices, image data (such as image data for one frame) by dividing the image data, and to methods therefor.

2. Description of the Related Art

The MPEG (Moving Picture Experts Group) method is a widely used method of encoding moving pictures. When image data, such as image data for one frame, is stored in a DRAM (Dynamic Random Access Memory) device in moving picture encoding devices using the MPEG method, it is possible to store the image data in one DRAM device at SD (Standard Definition) resolution, which is the standard resolution for television. However, when the image data is desired to be stored at HD (High Definition) resolution, which is a higher resolution than SD resolution, a plurality of DRAM devices are often required because it is difficult in view of the capacity and of the transference rate to write and read the image data by using only one DRAM device.

FIGS. 1 and 2 show conventional examples of the image data storage methods used in moving picture ecoding devices such as the above. In FIG. 1, the image data storage device comprises a logic LSI circuit 100 for processing images and two DRAM devices 101 and 102. The logic LSI circuit 100 includes an image processing unit 105 and a memory device controller 106.

As shown in FIG. 1, image data 1 through 3, each for one frame, is stored in the DRAM device 101, and image data 4 through 6 is stored in the DRAM device 102. Accordingly, the address calculation for accessing the memory devices can be conducted in a simple manner. As an example of the address calculation, when the image processing unit 105 makes, to the memory device controller 106, a data transference request of the image data 4, the status changes into the status in which only the DRAM device 102 can transfer data, and the DRAM device 101 waits; therefore, the determination of the transference rate of data depends on the transference rate of the DRAM device 102.

FIG. 2 shows the problem caused when the image processing unit 105 makes, to the memory device controller 106, data transference requests of the image data 4 and the image data 6. The DRAM device 102 cannot access the image data 6 while it is accessing the image data 4 even though it is acceptable for the DRAM 101 to enter the waiting status. In the H.264 method that was standardized by the ITU-T (International Telecommunication Union-Telecommunication Standardization Sector), it often occurs that many frames have to be accessed in image processing, and when the frames that are to be accessed are stored in one DRAM device, the data transference takes a long time. This can be a problem that causes a deterioration of system performance.

As a conventional technique of accessing memory for image processing such as the above, Patent Document 1 discloses an image processing system in which two image memory devices are provided, each of which has a plurality of banks each having a capacity that allows storing data for one frame, and data is written to one image memory device while data is read from the other memory device and vice versa in order to realize high-speed processing.

Patent Document 2 discloses an image memory circuit in which a DRAM device having two units each, including a plurality of banks, and writing to the DRAM devices are controlled such that the odd lines of image data are written first and the even lines of the image data are written next in order to accelerate data access.

Patent Document 3 discloses a display processing device that stores image data for one frame in two different banks corresponding to the switching of memory row addresses, and reads data alternately from the two banks, thereby realizing a reduction in access time in the case in which image data is read from regions having nonconsecutive addresses.

Patent Document 4 discloses a DRAM accessing method that can improve access efficiency by inputting two-dimensional images in the order of raster, and by storing the images in the DRAM while switching the banks 0 and 1.

However, even by using the above conventional techniques disclosed in Patent Documents 1 through 4, it is not possible to solve the problem, in image data storage devices having a plurality of memory devices, that accesses are converged on one memory device, and data transference thus takes a long time so that a large amount of data cannot be transferred in a short time.

### Patent Document 1

Japanese Patent No. 3001763, “Image processing system”

### Patent Document 2

Japanese Patent No. 3288327 “Image memory circuit”

### Patent Document 3

Japanese Patent Application Publication No. 2002-229551 “Display processing device”

### Patent Document 4

Japanese Patent Application Publication No. 2005-236946 “DRAM accessing method”

### SUMMARY OF THE INVENTION

It is an object of the present invention to improve image data processing performance in an image data storage device having a plurality of memory devices by reducing the probability of the access convergence on one memory device causing an elongated transference time and by making it possible to transfer a large amount of data in a short time.

An image data storage device according to the present invention, being the one comprising a plurality of memory devices, a data division unit for dividing image data into units of the constant number of consecutive lines corresponding to the plurality of memory devices, and a memory device control unit for sequentially storing, in the plurality of memory devices, the data divided into units of the constant number of consecutive lines.

According to the present invention, when image data in one rectangular region is accessed in one frame, a plurality of memory devices can be accessed simultaneously, and a large amount of data can be transferred in a short time. Thereby, even when a plurality of frames are to be accessed, time required for the data transference can be reduced, such that image processing performance can be improved.

### BRIEF DESCRIPTION OF THE DRAWINGS

FIG. 1 shows a conventional example of a method of storing image data;

FIG. 2 shows a conventional example of a method of accessing image data;

FIG. 3 is a principle configuration block diagram of an image data storage device according to the present invention;

FIG. 4 shows a method of storing data in an image data storage device according to a first embodiment;

FIG. 5 is a detailed configuration block diagram of a logic LSI circuit shown in FIG. 4;

FIG. 6 shows a method of accessing image data in a rectangular region according to the first embodiment;

FIG. 7 shows a method of storing data in an image data storage device according to a second embodiment; and

FIG. 8 shows a method of storing data in a DRAM device according to a third embodiment.

### DESCRIPTION OF THE PREFERRED EMBODIMENTS

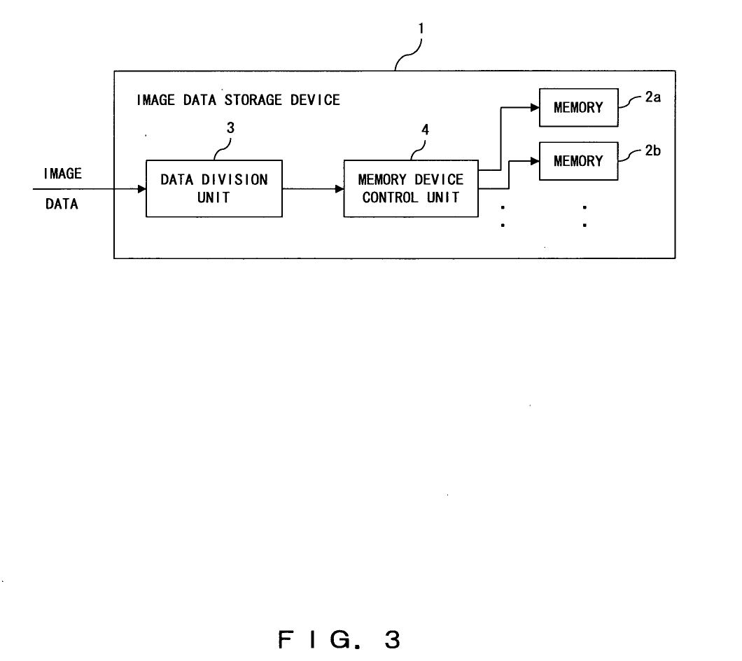

FIG. 3 is a principle configuration block diagram of an image data storage device for storing image data (such as image data for one frame) according to the present invention. A storage device 1 comprises a plurality of memory devices 2a, 2b . . . , a data division unit 3 and a memory device control unit 4.

The data division unit 3 divides the image data (such as the image data for one frame) into units of a certain constant number of consecutive lines corresponding to the plurality of memory devices 2a, 2b . . . . The memory device control unit 4 sequentially stores, in the memory devices 2a, 2b . . . , the data divided into units of the constant number of consecutive lines.

An image data access device according to the present invention has the same configuration as that shown in FIG. 3. The data division unit 3 divides the image data, such as the image data for one frame, into units of pixel rows each including the constant number of pixels. The memory device control unit 4 sequentially stores, in the memory devices 2a and 2b, the data divided into units of the pixel rows each including the constant number of pixels.

As a method of storing image data, the present invention uses a method in which the image data is divided into units of the constant number of consecutive lines corresponding to the plurality of memory devices, and the data divided into units of the constant number of consecutive lines are sequentially stored in the plurality of memory devices.

As another method of storing image data, the present invention uses a method in which the image data is divided into units of pixel rows each including the constant number of pixels, and the data divided into units of the pixel rows each including the constant number of pixels are sequentially stored in the plurality of memory devices.

As described above, in the present invention, data such as data for one frame is divided into units of the constant number of consecutive lines, and the divided data is sequentially stored in a plurality of, for example, two memory devices.

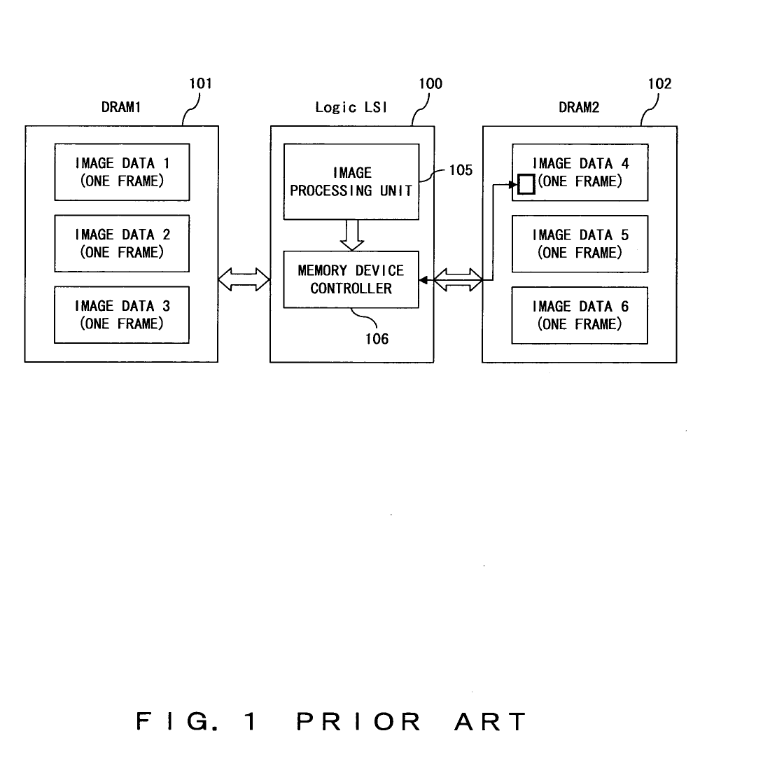

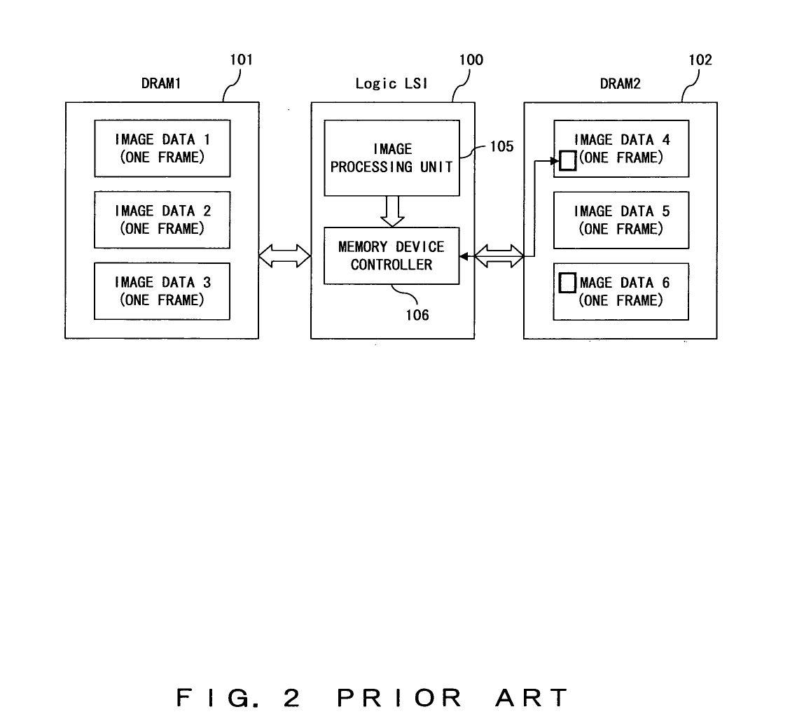

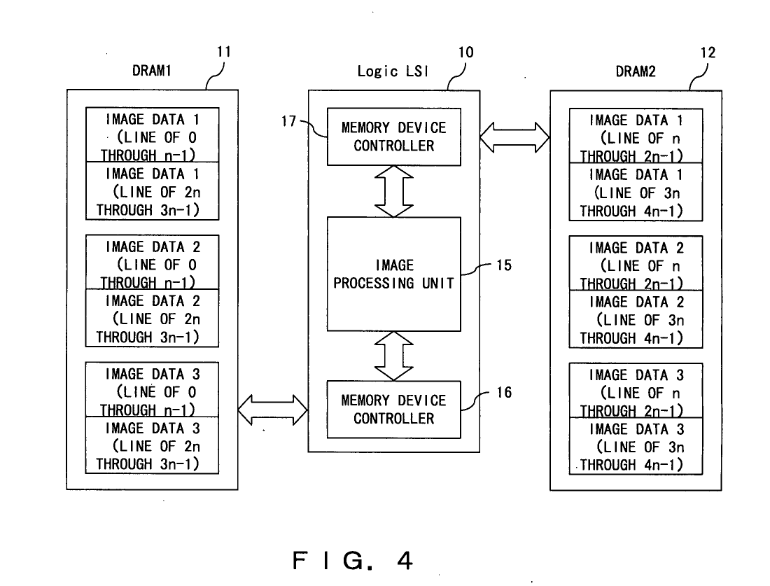

First, a first embodiment of the present invention will be explained by referring to FIGS. 4 through 6. FIG. 4 shows a method of storing data in an image data storage device according to the first embodiment. The image data storage device shown in FIG. 4 comprises, similarly to the conventional examples in FIGS. 1 and 2, a logic LSI circuit 10 for processing images and two DRAM devices 11 and 12. The logic LSI circuit 10 includes an image processing unit 15 and memory device controllers 16 and 17 for controlling the two DRAM devices 11 and 12.

In FIG. 4, image data for one frame, such as image data 1, is divided into data of the constant number “n” of consecutive lines. In this example, the image data is divided into data of four lines, i.e., the line of “0” through “n-1”, the line of “n” through “2n-1”, the line of “2n” through “3n-1”, and the line of “3n” through “4n-1”. The divided data is sequentially stored in the two DRAM devices 11 and 12. Image data 2 and image data 3 respectively for one frame are also divided and stored in the DRAM devices 11 and 12 in a similar manner. The number “n” of the lines can be arbitrarily set, and it is possible to divide the data for one frame into three or more groups, and to store them in three or more DRAM devices.

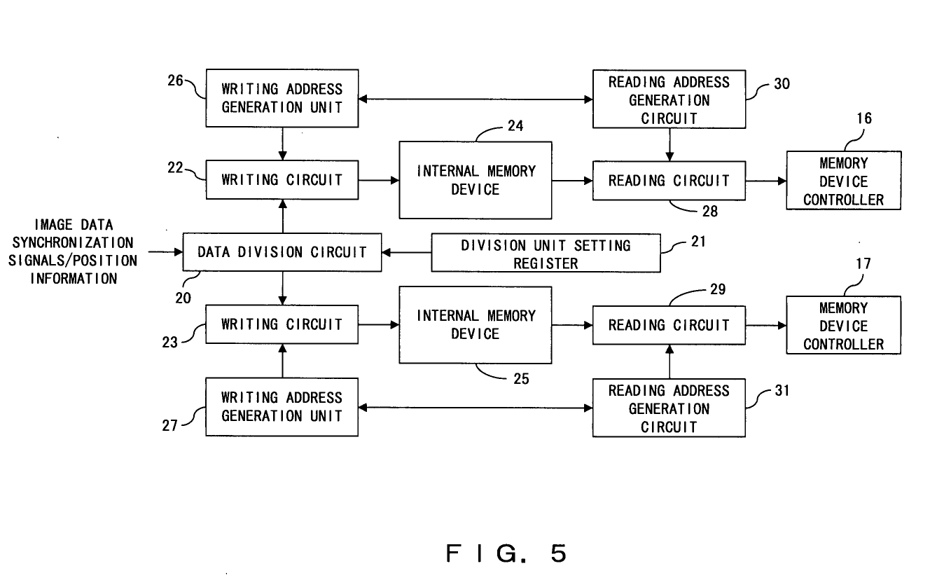

FIG. 5 is a detailed configuration block diagram of the logic LSI circuit 10 for image processing shown in FIG. 4. In FIG. 5, all of the units except for the two memory device controllers 16 and 17 correspond to the image processing unit 15 shown in FIG. 4.

In FIG. 5, a data division circuit 20 receives image data together with synchronization signals and position information. The data division circuit 20 divides image data such as image data for one frame in accordance with information stored in a division unit setting register 21, such as the constant number of consecutive lines, i.e., the value of the number of the lines “n” for example in FIG. 4, and supplies the divided data to two writing circuits 22 and 23. The writing circuits 22 and 23 respectively write the data to internal memory devices 24 and 25, which can be, for example, work memory devices, by using writing addresses generated by writing address generation units 26 and 27.

Reading circuits 28 and 29 for storage data in the DRAM devices 11 and 12 shown in FIG. 4 read data from the internal memory devices 24 and 25 in accordance with reading addresses generated by reading address generation circuits 30 and 31 when a particular amount of data to be written, i.e., when data to be transferred is accumulated. Thereafter, the reading circuits 28 and 29 supply the data to the memory device controllers 16 and 17, and the data is stored in the two DRAM devices 11 and 12. It is to be noted that the data division unit in claim 1 of the present invention corresponds to the data division circuit 20 and to the division unit setting register 21 shown in FIG. 5, and that the memory device control unit includes not only the memory device controllers 16 and 17 but also the writing circuit 22 and the reading address generation circuit 31.

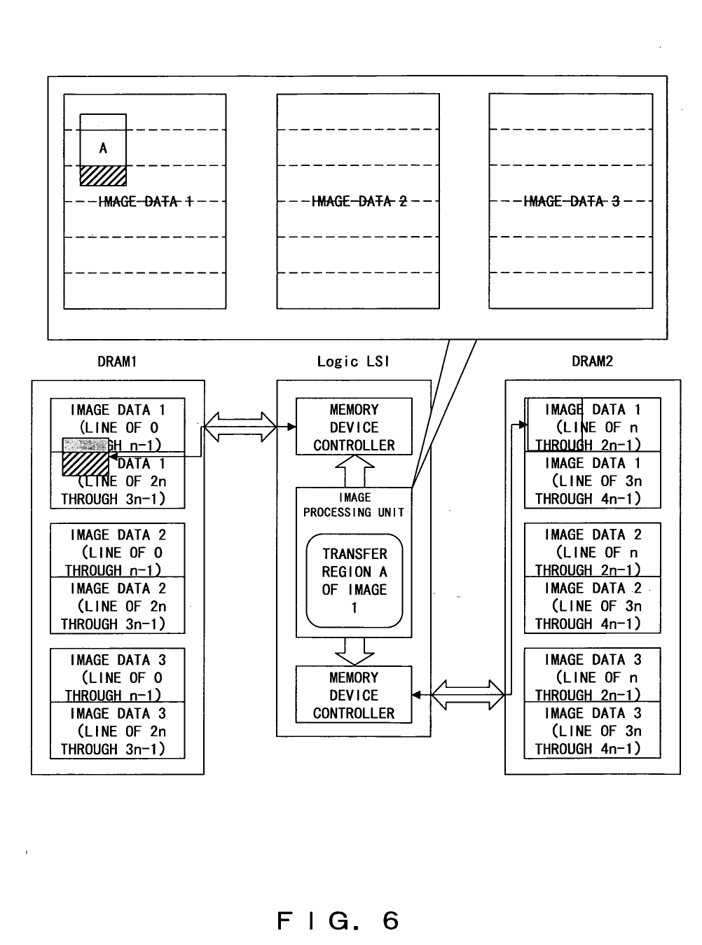

FIG. 6 shows a memory accessing method when image data for a rectangular region is transferred in a frame in the first embodiment. When it is assumed in FIG. 6 that data for the rectangular region A included in the image data 1 for one frame is accessed and that this data is divided and stored in the two DRAM devices 11 and 12, then the positions at which the transferred data is stored in the two DRAM devices are calculated in response to the request of the data transference of the region A in the image data 1 from the image processing unit 15 to the two memory device controllers 16 and 17 and the data transference is executed with the two DRAM devices operating simultaneously. With this configuration, a large amount of data can be transferred in a short time. Also, in the first embodiment, even when image data in a plurality of frames is accessed, the probability of the access convergence on one DRAM device causing an elongated transference time is reduced, and it is possible to make the data transference rate constant. Thereby, it is possible to improve various types of image processing.

In this first embodiment, the smaller the constant number “n” of the consecutive lines for the data division is, the easier it is to make the data transference rate constant. However, in the interlace method used in the image data processing, it is often difficult to make an access frequency constant when “n=1” because data is accessed by dividing the data into odd lines and even lines, i.e., into the top field and the bottom field.

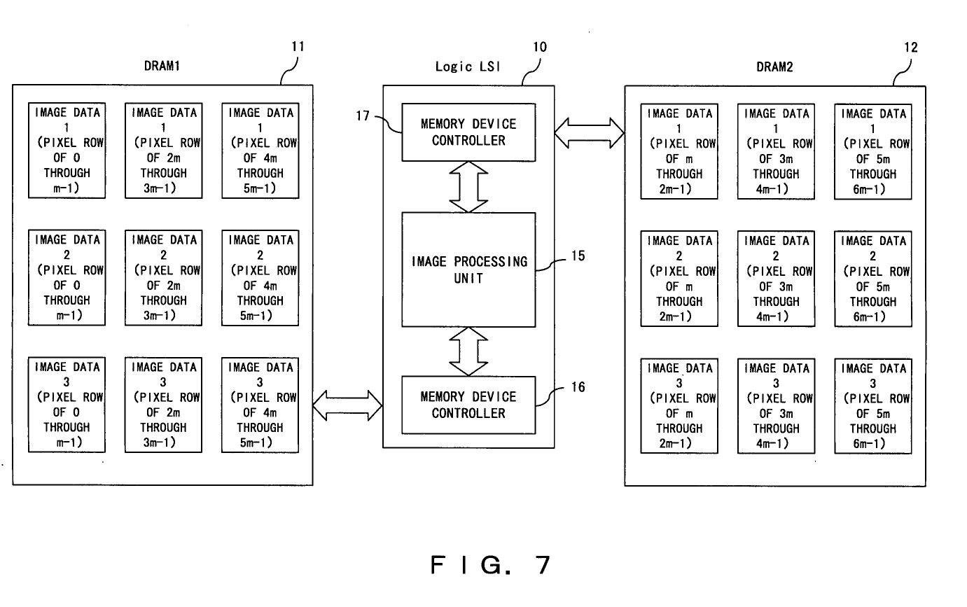

FIG. 7 shows a method of storing data in an image data storage device in a second embodiment. In this second embodiment, the image data (such as image data for one frame) is divided into units of pixel rows that each include the constant number of pixels, i.e., divided into units of the number “m” of pixels included in each pixel row in the horizontal direction, and the divided data is stored in a plurality of memory devices. As an example of this method, the pixel row including the pixels “0” through “m-1”, the pixel row including the pixels “2m” through “3m-1”, and the pixel row including the pixels “4m” through “5m-1” in the image data 1 are stored in the DRAM device 11, and the pixel row including the pixels “m” through “2m-1”, the pixel row including the pixels “3m” through “4m-1”, and the pixel row including the pixels “5m” through “6m-1” are stored in the DRAM device 12.

The logic LSI circuit 10 for the image processing in the second embodiment has a configuration that is basically the same as that shown in FIG. 5. The difference is that the number of pixel rows that each include the constant number of pixels, i.e., the number “m” of pixels included in each pixel row in the horizontal direction, is stored as in the division unit setting register 21.

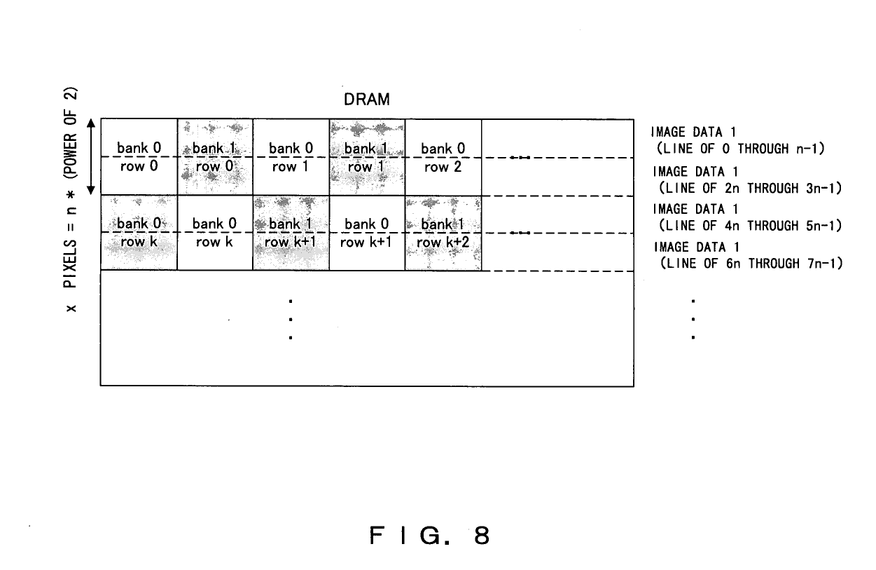

FIG. 8 shows a data storage method according to a third embodiment. In this third embodiment, it is assumed that the DRAM device consists of a plurality of banks, specifically a bank 0 and a bank 1. In the third embodiment, when the divided image data is stored in one memory row of the DRAM device, the constant number “n” of the lines is set such that the vertical length of the image is dividable by the constant number “n” of the lines. Specifically, when it is assumed that the number of pixels corresponding to a memory row is “x”, the number “n” of the lines is set to the number obtained by dividing the vertical length of the image by the power of two, corresponding to the number of the bits of the image data consisting of “x” pixels. Thereby, the storage region in the DRAM device can be effectively used.

In FIG. 8, it is also possible to improve the efficiency of access to the stored data by storing data in the memory rows in bank 0 and bank 1 after alternately arranging the data in a horizontal direction when the DRAM consists of the two banks of bank 0 and bank 1. In this embodiment, the method has been explained in which the image data is divided into units of the constant number of lines in a DRAM device consisting of a plurality of banks corresponding to the first embodiment; however, the same method can be applied to the case where the data is divided into units of pixel rows each including the constant number of pixels similarly as in the second embodiment.

What is claimed is:

1. An image data storage device, comprising:
a plurality of memory devices;
a data division unit for dividing image data into units of the constant number of consecutive lines corresponding to the plurality of memory devices; and
a memory device control unit for sequentially storing, in the plurality of memory devices, the data divided into units of the constant number of consecutive lines.

2. An image data storage device, comprising:
a plurality of memory devices;
a data division unit for dividing image data into units of pixel rows each including the constant number of pixels corresponding to the plurality of memory devices; and
a memory device control unit for sequentially storing, in the plurality of memory devices, the data divided into units of pixel rows each including the constant number of pixels.

3. The image data storage device according to claim 1 or 2, wherein:
each of the plurality of memory devices consists of dynamic random access memory (DRAM).

4. The image data storage device according to claim 1 or 2, wherein:
the memory device control unit comprises a plurality of memory device controllers respectively corresponding to the plurality of memory devices.

5. The image data storage device according to claim 3, wherein:
the vertical length of an image stored in one memory row in the DRAM is set by the data division unit to be the product of the constant number of lines and the power of two.

6. The image data storage device according to claim 3, wherein:
the horizontal length of an image stored in one memory row in the DRAM is set by the data division unit to be the product of the number of pixel rows each including the constant number of pixels and the power of two.

7. A method of storing image data, comprising:
dividing image data into units of the constant number of consecutive lines corresponding to a plurality of memory devices; and
sequentially storing, in the plurality of memory devices, the data divided into units of the constant number of consecutive lines.

8. A method of storing image data, comprising:
dividing image data in units of pixel rows each including the constant number of pixels corresponding to a plurality of memory devices; and
sequentially storing, in the plurality of memory devices, the data divided into units of pixel rows each including the constant number of pixels.

9. The method of storing image data according to claim 7 or 8, wherein:
each of the plurality of memory devices consists of dynamic random access memory (DRAM).
